(19) United States
(12) Patent Application Publication
(10) Pub. No.: US 2017/0230930 A1
(43) Pub. Date: Aug. 10, 2017

(54) Method And Arrangement For Commissioning A Building Automation System

(71) Applicant: Siemens Schweiz AG, Zuerich (CH)

(72) Inventor: Christian Frey, Unteraegeri (CH)

(73) Assignee: Siemens Schweiz AG, Zuerich (CH)

(21) Appl. No.: 15/425,356

(22) Filed: Feb. 6, 2017

(30) Foreign Application Priority Data
Feb. 9, 2016 (DE) 10 2016 201 883.3

(51) Int. Cl. H04W 64/00; H04W 4/00

(52) U.S. Cl. CPC H04W 64/003; H04W 4/008; H04L 67/42

(57) ABSTRACT

A method and system for commissioning a building automation system for a building are disclosed. A device that is installed or due to be installed in the building may have an identification code containing device-specific data relating to the device. A mobile communication terminal device of a user may capture the identification code, display a building plan for the building on a display of the mobile communication terminal device, and assign the device, based on a user input received at the mobile communication terminal device, to a location in the building plan and/or to other devices in the building plan that are installed or due to be installed. This assignment may be stored in the building automation system.

### CROSS-REFERENCE TO RELATED APPLICATIONS

This application claims priority to DE Application No. 10 2016 201 883.3 filed Feb. 9, 2016, the contents of which are hereby incorporated by reference in their entirety.

### TECHNICAL FIELD

The invention relates to a method and an arrangement for commissioning a building automation system for a building. The invention further relates to a computer program and a computer-readable medium having commands that are executable on a computer for the purpose of commissioning a building automation system for a building.

### BACKGROUND

In the commissioning of a building automation system, the installation position of a building automation field device (e.g. fire detector, thermostat, etc.) must be documented in a building plan after its installation in the building so that the physical assignment to the respective installation site can be completed later, along with other details, in a control center or a building management system.

In addition to the installation position, it is also necessary to log other device-specific data, such as device type, serial number, ID, and possibly further attributes of the respective field device. A further requirement during the commissioning of the building automation system is to define the logical assignment (linking) of the installed devices. Thus, a sensor needs to know in which room it has been installed and which assigned actuator (final control element) it must activate, or whether it requires measurement data from neighboring sensors, if any. Accordingly, it is necessary e.g. for a fire alarm control panel to know whether a state of dependence exists between one fire detector and a neighboring fire detector that is installed in the same room (dual-detector dependency for triggering an alarm), or whether in the event of a fire an associated magnetic door holder must release in order to ensure that the associated fire protection door closes. In the prior art, such assignments are carried out manually by the commissioning engineer on the basis of the existing building plans. These manual assignments are susceptible to error. Transmission errors may occur due to lack of concentration, which may lead e.g. to a situation where a thermostat controls the neighboring room. Furthermore, the work of a commissioning engineer is very time-intensive, which additionally results in high labor costs.

### SUMMARY

One embodiment provides a method for commissioning a building automation system for a building, wherein a device that is installed or due to be installed in the building comprises an identification code containing device-specific data relating to the device wherein the identification code is captured by a mobile communication terminal device of a user, wherein a building plan for the building is displayed on a display of the mobile communication terminal device, wherein the device that is installed or due to be installed is assigned by a user input on the mobile communication terminal device to a location in the building plan and/or to other devices in the building plan that are installed or due to be installed, wherein the assignment is stored in the building automation system.

In one embodiment, the assignment is realized by an entry in a digital building model of a server associated with the building automation system.

In one embodiment, the entry in the digital building model is carried out online by the user input on the mobile communication terminal device.

In one embodiment, the entry in the digital building model is carried out offline by a synchronization of the building plan stored in the mobile communication terminal device with the digital building model at specific times or after defined events.

In one embodiment, the identification code is captured by reading in the identification code on the mobile communication terminal device.

In one embodiment, a device that is installed or due to be installed is entered in a local or online database (product catalog) and can be displayed on the display of the communication terminal device, and the device that is installed or due to be installed is assigned to a location in the building plan and/or to other devices in the building plan that are installed or due to be installed by a manual selection by the operator.

In one embodiment, the location for a suitable device that is to be installed is displayed on the building plan stored in the mobile communication terminal device.

In one embodiment, the current position of the user is calibrated on the building plan displayed on the mobile communication terminal device, based on position information received in the mobile communication terminal device from an indoor positioning system.

In one embodiment, the user input on the mobile communication terminal device for the assignment is effected by acoustic input, by tactile input, or by a user gesture.

Another embodiment provides a computer program for commissioning a building automation system, comprising instructions for performing a method as disclosed above.

Another embodiment provides a computer-readable medium having commands that are executable on a computer or processor for the purpose of commissioning a building automation system according to a method as disclosed above.

Another embodiment provides an arrangement for commissioning a building automation system for a building, wherein devices installed or due to be installed in the building have a machine-readable identification code containing device-specific data relating to the respective device, the arrangement comprising: a mobile communication terminal device that is suitable for capturing the identification code of the device that is due to be installed or for selecting the device that is due to be installed on the communication terminal device by a user, wherein a building plan of a digital building model for the building is loaded in the mobile communication terminal device and can be displayed on the display of the communication terminal device; a server for the building automation system, which server is connected to the mobile communication terminal device by way of a wireless communication connection and comprises the digital building model for the building; wherein a device that is installed or due to be installed, and whose identification code has been read in, is assigned by a user input on the mobile communication terminal device to a location in the building plan and/or to other devices in the building plan that are installed or due to be installed, wherein the assignment is stored in the server of the building automation system and is realized by a corresponding entry in the digital building model.

### BRIEF DESCRIPTION OF THE DRAWINGS

Example aspects and embodiments of the invention are explained below with reference to the figures, in which:

FIG. 1 shows an exemplary scenario for the use of the method according to the invention,

FIG. 2 shows an exemplary mobile communication terminal device, suitable for the use of the method according to the invention, and

FIG. 3 shows an exemplary flowchart for a method for commissioning a building automation system for a building.

### DETAILED DESCRIPTION

Embodiments of the present invention provide a method and an arrangement for commissioning a building automation system for a building which ensure a reliable assignment of field devices in a building to their representation in a building plan.

Some embodiments provide a method for commissioning a building automation system for a building, wherein a device that is installed or due to be installed in the building comprises an identification code containing device-specific data relating to the device, wherein the identification code is captured by a mobile communication terminal device (e.g. smartphone, tablet computer) of a user, wherein a building plan for the building is displayed on a display of the mobile communication terminal device, wherein the device that is installed or due to be installed is assigned by a user input on the mobile communication terminal device to a location in the building plan and/or to other devices in the building plan that are installed or due to be installed, wherein the assignment is stored in the building automation system. The identification code may be captured by the code being optically read in or scanned by an appropriately equipped mobile communication terminal device, e.g. by a scanning program (scan app) that is installed on the communication terminal device. In this embodiment variant, the identification code is advantageously attached to the device in machine-readable form, e.g. as a QR code, as a barcode, or as a data matrix code (DMC) or NFC tag, or as an RFID tag. Alternatively, the identification code may also be captured by the user (e.g. by the commissioning engineer) by manual selection of a corresponding device from a list that can be displayed on the display of the communication terminal device. It is, of course, also possible to use both code acquisition methods in tandem, or to switch back and forth between the two acquisition methods.

According to a first embodiment, the assignment is carried out by an entry in a digital building model (computer model) of a server associated with the building automation system (BIM server). The building plan is advantageously part of a virtual or digital building model (BIM=Building Information Modeling) for the building. The building or, as the case may be, subordinate aspects or subsidiary sections thereof is or are recorded in a form suitable for data processing in a model in an appropriate notation and advantageously stored in a database, e.g. in the IFC (Industry Foundation Class) format. The digital building model may be exchanged with other interested parties (e.g. facility management, building services, fire protection officers) of a building management system, or other interested parties have access thereto. A digital building model assures a consistent view and consistent data storage and management for the corresponding building. The database containing the virtual or digital building model is advantageously resident on a BIM server which is connected to the building management system.

According to a further embodiment, the entry in the digital building model is made online, by the user input on the mobile communication terminal device. A building plan for the building is advantageously displayed on the mobile communication terminal device by a browser or viewer (e.g. by browser plug-in or app). As part of the digital or virtual building model (BIM=Building Information Modeling), the building plan is located on the BIM server. By completing the entry in the digital building model online it is ensured that an up-to-date map of the current installation situation in the building is stored in the building model at all times.

According to a further embodiment, the entry in the digital building model is made offline, by a synchronization of the building plan stored in the mobile communication terminal device with the digital building model at specific times or after defined events. The building plan for the building may be transferred to the mobile communication terminal device e.g. by a download from the BIM server. The synchronization of the building plan stored in the mobile communication terminal device with the digital or virtual building model of the BIM server may be initiated automatically at specific times (e.g. every hour or overnight) or after defined events (e.g. when a specified number of code entries is reached), or it may be triggered manually. An offline synchronization of the captured data with the building model on the BIM server makes sense in particular when transferring large or complex volumes of data.

According to a further embodiment, the identification code is captured by reading in the identification code on the mobile communication terminal device. In this embodiment variant, the identification code is advantageously affixed to the device in machine-readable form, e.g. as an NFC tag or RFID tag, as a QR code, as a barcode, or as a data matrix code (DMC). The identification code may be captured by optically reading in or scanning the code by an appropriately equipped mobile communication terminal device, e.g. by a scanning program (scan app) that is installed on the communication terminal device. The mobile communication terminal device is advantageously a COTS (Commercial Off-The-Shelf) device that is generally available on the market.

According to a further embodiment, a device that is installed or due to be installed is entered in a local or online database (product catalog) and can be displayed on the display of the communication terminal device, and the assignment of said device that is installed or due to be installed to a location in the building plan and/or to other devices in the building plan that are installed or due to be installed is made by a manual selection by the operator. The manual selection is advantageously carried out by selecting from corresponding lists, e.g. by selection from a dropdown menu (e.g. dropdown list, dropdown list field) or a pulldown menu. The choice is made by selection (e.g. tapping) and visual verification.

According to a further embodiment, the location for a suitable device that is due to be installed is displayed on the building plan stored in the mobile communication terminal device. The nearest device that is ready to be installed is advantageously output or displayed on the communication terminal device. This may be realized visually by directions presented on the display of the communication terminal device and/or acoustically by announcement of the directions. By indicating the optimal path through the building, the time required for a commissioning operation is reduced, in particular for a commissioning engineer who is unfamiliar with the location. Furthermore, mounting or installation aids may also be displayed, or also which tools it is necessary to use.

According to a further embodiment, the current position of the user on the building plan displayed on the mobile communication terminal device is calibrated, based on position information received in the mobile communication terminal device from an indoor positioning system. If the mobile communication terminal device is located within a radio transmission range of a transmitting device of an indoor positioning system, the mobile objects are calibrated or recalibrated based on the position information received in each case in the respective radio transmission range by the mobile communication terminal device. The transmitting device with the unique position information in each case associated therewith acts like a reference beacon for the calibration or recalibration. The transmitting device may be e.g. a WLAN, Bluetooth or ZigBee transmitter, or a combination of transmitters (beacons).

According to a further embodiment, the user input on the mobile communication terminal device for the purpose of the assignment is effected by acoustic and/or tactile input (e.g. by written input, by selection from a list, or by “dragging and dropping” corresponding symbols, and/or by a gesture of the user). In this case the mobile communication terminal device is equipped with the appropriate input device (e.g. touchscreen).

Other embodiments provide a computer program for commissioning a building automation system, said computer program comprising instructions for performing the disclosed method. The computer program may be loaded into the memory of the mobile communication terminal device via a wired or a wireless data transfer. A wireless data transfer is advantageously realized via a download of the program from the internet or from a control center, e.g. a building control center, or from a building management system to which the mobile communication terminal device is connected for data processing and communication purposes.

Other embodiments provide a computer-readable medium (e.g. SD card, CD, USB memory stick) on which are stored commands that are executable on a computer for the purpose of performing the disclosed method.

Other embodiments provide an arrangement for commissioning a building automation system for a building, wherein devices that are installed or due to be installed in the building have a machine-readable identification code (e.g. NFC tag, RFID tag, QR code, barcode, data matrix code) containing device-specific data (including IFC/BIM data) relating to the respective device (e.g. fire detector, temperature sensor, thermostat, etc.), the arrangement comprising:
a mobile communication terminal device (e.g. smartphone, tablet computer) suitable for capturing the identification code of the device that is due to be installed or for selection of the device that is due to be installed on the communication terminal device by a user, wherein a building plan of a digital/virtual building model for the building is loaded in the mobile communication terminal device, which building plan can be displayed on the display of the communication terminal device;
a server for the building automation system, which server is connected to the mobile communication terminal device by way of a wireless communication connection and comprises the digital building model for the building, wherein a device that is installed or due to be installed, and whose identification code has been read in, is assigned via a user input on the mobile communication terminal device to a location (3D local position) in the building plan and/or to other devices in the building plan that are installed or due to be installed, wherein the assignment is stored in the server of the building automation system and is realized by a corresponding entry in the digital building model. The entry in the digital/virtual building model may be made online by a corresponding communication connection between the mobile communication terminal device and the server (BIM server) of the building automation system, or offline automatically at specific synchronization times or, as the case may be, after activation by the user. The identification code for a device that is due to be installed may be captured by selection from a list on the communication terminal device and/or by the machine-readable identification code that is affixed to the device that is due to be installed being read in via a read unit (e.g. camera or tag reader) of the mobile communication terminal device having corresponding scanning and processing software.

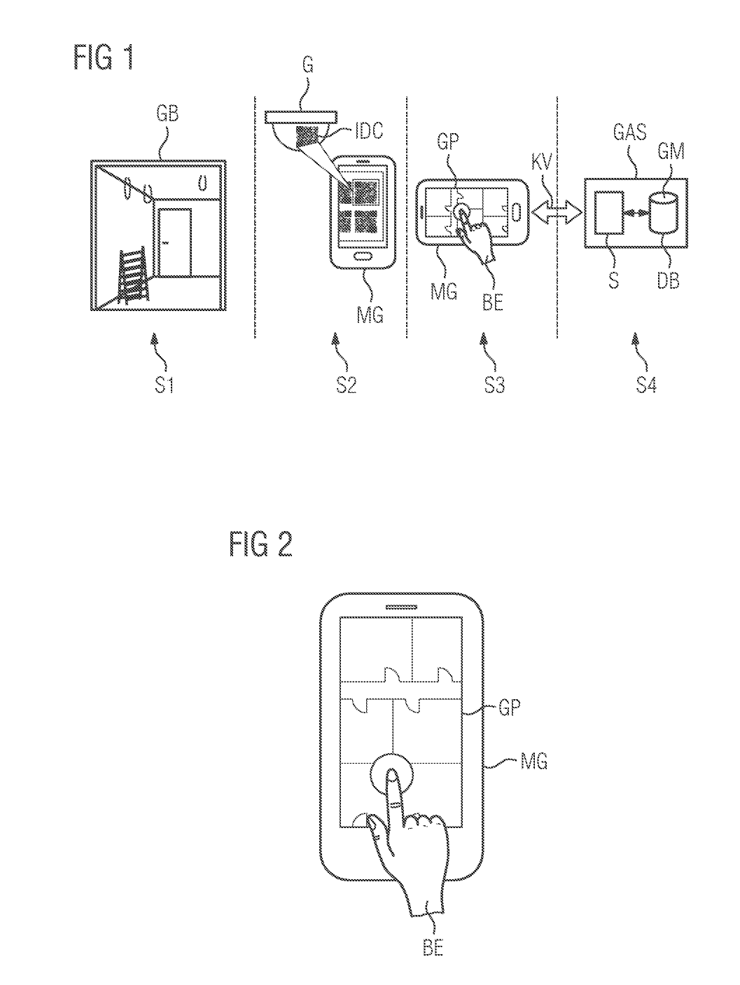

FIG. 1 shows an exemplary scenario for the use of the disclosed method for commissioning a building automation system GAS for a building GB.

Scenario step S1 shows an exemplary room of a building GB in which devices (e.g. fire detectors, actors, sensors, lighting equipment) are being or have been installed on the ceiling.

Scenario step S2 shows, as an exemplary device G that is due to be installed or has been installed, a fire detector which is provided with a machine-readable identification code IDC. The identification code IDC is advantageously affixed to the outside of the device so as to be visible. This enables the identification code IDC to be read in directly via a communication terminal device MG (e.g. smartphone, tablet computer) without the need for mounting or installation activities. In this case the communication terminal device MG is provided with an appropriate piece of software (e.g. scan app) and corresponding read-in hardware (e.g. camera). Suitable candidates for use as an identification code IDC include e.g. NFC tags, RFID tags, QR codes, data matrix codes (DMC) or barcodes. In principle it would also be possible to place the identification code IDC inside the housing of the device G, e.g. on the inner face of the housing, but in that case it would first be necessary, before reading in the identification code IDC, to unfix the device and then reinstall it again afterward. (This is not absolutely necessary in the case of radio tags (e.g. NFC, RFID)). The identification code IDC ensures the respective device (field device) bears a unique marking. Advantageously, the identification code IDC will optionally include further information about the installed device, such as e.g. serial number, device type, maintenance intervals, manufacturer, supplier, in addition to the unique marking.

Scenario step S3 shows how the device G whose identification code IDC was read in in scenario step S2 is assigned to a location in the building plan GP and/or to other devices G in the building plan GP that have been or are due to be installed. According to one assignment possibility, the building plan GP for the building GB may be displayed on the display of the mobile communication terminal device MG, and the device G whose identification code IDC was read in in scenario step S2 being assigned via a user input BE on the mobile communication terminal device MG to a location in the building plan and/or to other devices G in the building plan GP that have been or are due to be installed. The user input BE may entail e.g. a manual selection of a room or of another device in the building plan. The user input BE is advantageously realized by “tapping” at the corresponding point in the building plan GP, which is presented on a touch-sensitive display (touch interface) of the communication terminal device MG. Immediately after the identification code IDC has been read in (e.g. after being scanned in), the building plan GP is advantageously displayed on the communication terminal device MG in a state ready for an assignment. After the identification code IDC has been read in (e.g. after being scanned in), the building plan GP is advantageously displayed on the communication terminal device MG in a state ready for an assignment after the communication terminal device MG has been rotated through at least 90 degrees.

Scenario step S4 shows how the assignment is stored in the building automation system GAS. In this case the assignment is advantageously stored in a storage device DB of the server S of the building automation system GAS by way of a wireless communication connection KV (e.g. internet, WLAN, radio link, satellite link). The storage device DB may be e.g. a flash memory or an in-memory database (IMDB). The server S is an appropriately equipped computer (e.g. workstation, PC, laptop) having suitable communication mechanisms or interfaces in order in particular to establish a communication connection KV to the mobile communication terminal device MG of a user (e.g. installer, commissioning engineer).

A building automation or building management system GAS controls and monitors administrative and operative functions for a building, such as e.g. with regard to asset management, facility management, etc., but also with regard to access control. In particular, the operating state of infrastructure present in the building (e.g. heating systems, ventilation systems, air conditioning systems, sensors, actors, actuators) is also monitored by the building automation system GAS and if necessary relevant service or maintenance activities are initiated. It is therefore especially important for a building automation system GAS to have access to information in respect of field devices (e.g. fire detectors) that are installed in the building. Accordingly, it is necessary for the building automation system GAS to know which types of field devices have been installed and where these are located in the building or, as the case may be, with which further field devices a specific field device cooperates (e.g. when an actor-sensor relationship exists). These location assignments or cooperation assignments are normally carried out within the scope of the commissioning process and are stored for the purpose of electronic evaluation or further processing within the framework of a building data modeling project in a corresponding building information model (BIM=Building Information Modeling). As a result, all current and relevant building data is immediately and consistently available to all parties involved in the construction or operation of a building. The building information model, i.e. the digital/virtual building model, is advantageously stored in a data modeling technique and in a corresponding notation (e.g. Object Modeling Technique (OMT)) or IFC (Industry Foundation Classes), wherein connections and relations between objects (e.g. field devices) in the building are represented.

For the commissioning of the building automation system, a field device is assigned to a location in the building plan GP via a corresponding entry in the digital/virtual building model (building information model) of the BIM server S associated with the building automation system.

The entry in the digital building model may be made online, via a user input into a browser of the mobile communication terminal device MG (e.g. smartphone, tablet computer), or offline, via a synchronization of the building plan stored in the mobile communication terminal device with the digital/virtual building model at specific times (e.g. outside working hours, or every hour) or after defined events (e.g. after a specified number of scanning operations).

Advantageously, the mobile communication terminal device MG is equipped with appropriate hardware (camera, read-in sensors) and software (scan app) for capturing the identification code IDC. Once the commissioning has been completed, the commissioning engineer will advantageously also take a photo of the device G with the mobile communication terminal device MG and send this together with the identification code IDC to the BIM server. In the digital/virtual building model (BIM model) GM, said photo will be stored as meta information associated with the corresponding device object.

In the event of a change to the room planning, the logical links between the installed building automation field devices are advantageously checked and possibly a new logical assignment is carried out. In the event of a room planning change, the commissioning engineer will advantageously be informed automatically on his or her mobile communication terminal device MG by the building automation system GAS via the bidirectional communication connection KV.

BIM servers S are already deployed in numbers in the construction during the design phase and contain a “digital twin” of the building, i.e. an object model GM as a digital map of the building GB. For example, it is possible with the aid of a smartphone or tablets and augmented-reality software to enter the building model GM virtually and discover where the individual building disciplines are installed in the building GB and how these are linked to one another. Accordingly, the installation sites for the field devices G are advantageously determined in advance in the planning phase and entered into the digital building model GM. The implementation of the building works is already preplanned and functionalities are simulated where necessary in order to reduce potential conflicts. The planning and commissioning of the building disciplines will be improved as a result.

The data matrix code labels IDC of the devices G are henceforth no longer first pasted into a 2D plan and scanned from this plan (paper) after installation. Instead, the reading device MG (tablet or smartphone) is advantageously used to transfer the data and the position of the building automation field device G immediately on site following the installation directly to a BIM server S, in which the digital building model GM is stored in a corresponding storage device DB (e.g. flash memory).

Alternatively, the building plan GP (as part of the building model GM) may first be loaded onto the communication terminal device MG and is thus available offline on the construction site (e.g. to the commissioning engineer). The synchronization with the BIM server S is then carried out when the communication terminal device MG is online once more. To that end, the DMC of the device G that is due to be installed (e.g. fire detector) is first scanned and then the device is physically fixed in place. Subsequently rotating the communication terminal device MG (e.g. smartphone, tablet computer) advantageously causes the digital building plan (2D or 3D) GP to appear on the display of the communication terminal device MG. The already integrated digital object is then clicked on at the predetermined location in the digital building plan GP.

The DMC (as identification code IDC) and the “digital position” in the plan GP are thus linked. In addition, a serial number may be appended, a photo of the duly completed installation may also be taken for documentation purposes, or further comments may be added and likewise linked.

A further possible advantage is that the system suggests in advance the installation site for the next fire detector that is due to be installed and displays the “virtual or digital position” on the reading device. An optimal commissioning route is thus proposed to the commissioning engineer by the system.

If an “indoor positioning system” (IPS) is already present during the installation (e.g. iBeacons, WiFi access points), it is possible to verify the “digital position” with the real position. Alternatively, reference positions in the building can be “mapped” with the digital plan and taken as the starting point for an indoor navigation. With the aid of the sensor technology available in a smartphone (gyrometer, compass, acceleration sensor, barometer, etc.) it is thus also possible to determine the approximate position of the installation site.

The position of the fire detector G and also its links and relationships may be checked, in particular after partition walls have been moved or erected. To that end, the system may also provide support by highlighting conflicts graphically.

Other embodiments provide a system for commissioning a building automation system for a building GB, wherein devices G that are installed or due to be installed in the building GB have a machine-readable identification code IDC containing device-specific data relating to the respective device G, the arrangement comprising:
a mobile communication terminal device MG that is suitable for capturing the identification code IDC of the device G that is due to be installed or for the selection of the device G that is due to be installed on the communication terminal device MG by a user (e.g. commissioning engineer), wherein a building plan GP of a digital building model GM for the building GB is loaded in the mobile communication terminal device MG and can be displayed on the display of the communication terminal device MG;
a server S (e.g. workstation, PC with appropriate hardware and software) for the building automation system GAS, which server S is connected to the mobile communication terminal device MG by way of a wireless communication connection KV (e.g. radio link) and comprises the digital building model GM for the building GB, wherein a device G that is installed or due to be installed, and whose identification code IDC has been read in, is assigned via a user input BE (e.g. tapping on the touch display) on the mobile communication terminal device MG to a location in the building plan GP and/or to other devices G in the building plan GP that are installed or due to be installed, wherein the assignment is stored in the server S of the building automation system GAS and is made via a corresponding entry in the digital building model GM.

The digital building model GM is stored in an appropriate format (e.g. IFC or an object model known from information technology (e.g. OMT, UML) in a storage device DB (e.g. in-memory database or flash memory) of the server S.

FIG. 2 shows an exemplary mobile communication terminal device MG that is suitable for the use of the disclosed method according to one embodiment of the invention. The mobile communication terminal device MG (e.g. smartphone, tablet computer) is connected by way of a bidirectional communication connection to the server of a building automation system in order to transfer data online, i.e. in real time or at specific times or after defined events, in batch operating mode. Using appropriate sensor technology (e.g. camera or read optics) of the mobile communication terminal device MG, a user (e.g. installer, commissioning engineer) is able to capture the identification code of a device G that is due to be installed in a building and assign the same by way of a user input BE (e.g. manual selection or tapping on a touch-sensitive display) to a location in the building plan GP. The building plan GP is meanwhile displayed on the display of the communication terminal device MG. This assignment is transmitted by way of the communication connection to the server (BIM server), where it is accordingly stored in the building model (BIM model). The mobile communication terminal device MG is advantageously a commercially available device (e.g. smartphone).

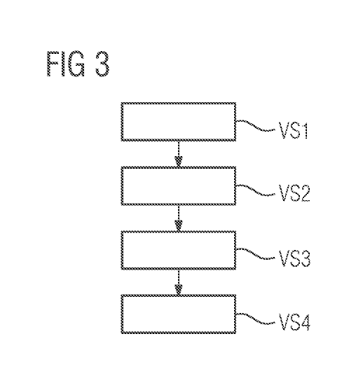

FIG. 3 shows an exemplary flowchart for a method for commissioning a building automation system for a building, wherein a device that is installed or due to be installed in the building comprises an identification code (e.g. data matrix code, barcode, QR code or NFC tag, or RFID tag) containing device-specific data relating to the device,
(VS1) wherein the identification code is captured by a mobile communication terminal device (e.g. smartphone, tablet computer) of a user,
(VS2) wherein a building plan for the building is displayed on a display (preferably a touch display) of the mobile communication terminal device,
(VS3) wherein the device that is installed or due to be installed is assigned via a user input on the mobile communication terminal device to a location in the building plan and/or to other devices in the building plan that are installed or due to be installed,
(VS4) wherein the assignment is stored in the building automation system.

The assignment is advantageously made via an entry in a digital building model (e.g. IFC model or object model) of a server associated with the building automation system.

The entry in the digital building model is advantageously carried out online via a user input in a browser on the mobile communication terminal device.

The entry in the digital building model may also be carried out offline or in batch operating mode, e.g. via a synchronization of the building plan stored in the mobile communication terminal device with the digital building model at specific times or after defined events.

The identification code is advantageously captured by reading in the identification code on the mobile communication terminal device by appropriate read-in software (e.g. scan app or barcode reader or NFC reader, or RFID reader).

The method may be realized in a computer-aided manner by commercially available hardware (e.g. commercially available servers having a suitable database for the digital building model) and software (e.g. scan app on communication terminal device, or browser plug-in).

In particular, embodiments of the present invention may offer one or more of the following advantages:
This invention digitalizes the commissioning process further and avoids the step whereby the DMC stickers are “laboriously” pasted into a 2D paper plan, as well as the subsequent transfer into a planning tool (such as e.g. Sinteso Works) or into a database.
Commissioning engineers and service technicians are able to carry out their work more effectively (e.g. next installation site is displayed) and more reliably and are supported in the auditing and verification of the completed subtasks. The task is flagged as “completed” only when all of the field devices (fire detectors) planned in the BIM have been processed. This information is then available to all of the interested parties (developer, architect, site manager, . . . ) by way of the BIM server, increases transparency and consequently facilitates project control and tracking to an enormous degree.
The unique identification of the field devices (DMC or other machine-readable codes), the app on the smartphone (reading device) and its connection to the BIM server, or the loading of corresponding building plans enable this technical method to be realized in a simple manner.
A substantial improvement in the documentation of the installed devices is achieved.
The commissioning time is substantially shortened, which provides benefits in terms of high cost savings.
The quality of the commissioning is substantially increased by transparency and traceability.
In particular changes during the planning and usage phase of the building are easy to document.
No (up-to-date) paper plans need to be found and modified.
The progress of the project is available effectively in real time to all interested parties.

A method and corresponding arrangement for commissioning a building automation system for a building, wherein a device that is installed or due to be installed in the building comprises an identification code containing device-specific data relating to the device, wherein the identification code is captured by a mobile communication terminal device of a user, wherein a building plan for the building is displayed on a display of the mobile communication terminal device, wherein the device that is installed or due to be installed is assigned via a user input on the mobile communication terminal device to a location in the building plan and/or to other devices in the building plan that are installed or due to be installed, wherein the assignment is stored in the building automation system.

### REFERENCE SYMBOLS

GB Building

GAS Building automation system

GP Building plan

GM Building model

MG Communication terminal device

KV Communication connection

G Device

IDC Identification code

DMC Digital matrix code

BE User input

S1-S4 Scenario step

VS1-VS4 Method step

What is claimed is:

1. A method for commissioning a building automation system for a building,
wherein a device that is installed or to be installed in the building comprises an identification code containing device-specific data relating to the device, the method comprising:
capturing the identification code using a mobile communication terminal device of a user,
displaying a building plan for the building on a display of the mobile communication terminal device,
assigning, based on a user input received via the mobile communication terminal device, the device that is installed or to be installed to at least one of (a) a location defined in the building plan or (b) other devices defined in the building plan that are installed or to be installed, and
storing the assignment in a memory device of the building automation system.

2. The method of claim 1, wherein the assignment is performed via an entry in a digital building model of a server associated with the building automation system.

3. The method of claim 2, wherein the entry in the digital building model is performed online based on the user input via the mobile communication terminal device.

4. The method of claim 2, wherein the entry in the digital building model is performed offline by a synchronization of the building plan stored in the mobile communication terminal device with the digital building model at specific times or after defined events.

5. The method of claim 1, wherein the identification code is captured by reading in the identification code via the mobile communication terminal device.

6. The method of claim 1, comprising:
entering the device that is installed or to be installed in a product catalog database, and
the assignment of the device that is installed or due to be installed to at least one of (a) a location in the building plan or (b) other devices in the building plan that are installed or to be installed is performed by a manual user selection.

7. The method of claim 1, comprising displaying a location for a suitable device that is to be installed on the building plan stored in the mobile communication terminal device.

8. The method of claim 1, comprising calibrating a current position of the user on the building plan displayed on the mobile communication terminal device, based on position information received at the mobile communication terminal device from an indoor positioning system.

9. The method of claim 1, wherein the user input via the mobile communication terminal device for the assignment comprises an acoustic input, a tactile input, or a gesture by the user.

10. A computer program for commissioning a building automation system, wherein a device that is installed or to be installed in the building comprises an identification code containing device-specific data relating to the device,
wherein the computer program comprises instructions stored in non-transitory computer-readable media of a mobile communication terminal device of a user and executable by a processor of the mobile communication terminal device to:
capture the identification code,
display a building plan for the building on a display of the mobile communication terminal device,
assign, based on a user input received via the mobile communication terminal device, the device that is installed or to be installed to at least one of (a) a location defined in the building plan or (b) other devices defined in the building plan that are installed or to be installed, and
store the assignment in a memory of the building automation system.

11. A system for commissioning a building automation system for a building, wherein devices installed or due to be installed in the building have a machine-readable identification code containing device-specific data relating to the respective device, the system comprising:
a mobile communication terminal configured to:
capture the identification code of a device or receive a user selection the device to be installed;
store a building plan of a digital building model for the building in memory of the mobile communication terminal, the building plan being displayable via a display device of the communication terminal;
based on a user input received via the mobile communication terminal device, assign the device to at least one of (a) a location defined in the building plan or (b) other devices defined in the building plan, and
a server for the building automation system, wherein the server is configured to:
communicate with the mobile communication terminal via a wireless communication connection;
store the digital building model for the building; and
store the assignment of the device to the at least one of (a) a location defined in the building plan or (b) other devices defined in the building plan, wherein the assignment is stored as a corresponding entry in the digital building model stored in the server.
